(19) United States
(12) Patent Application Publication
(10) Pub. No.: US 2006/0144091 A1
(43) Pub. Date: Jul. 6, 2006

(54) Glass melting apparatus and glass melting method

(75) Inventors: Hiroaki Kato, Tokyo (JP); Eiichi Nakaoka, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Nippon Sheet Glass Company, Limited

(21) Appl. No.: 11/365,728

(22) Filed: Feb. 28, 2006

Related U.S. Application Data
(63) Continuation of application No. PCT/JP04/12757, filed on Aug. 27, 2004.

(30) Foreign Application Priority Data
Aug. 29, 2003 (JP) 2003-307648
Aug. 27, 2004 (WO) PCT/JP04/12757

(51) Int. Cl. C03B 5/02; C03B 5/027; C03B 3/00

(52) U.S. Cl. 65/135.6; 65/135.7; 65/335; 65/DIG. 4

(57) ABSTRACT

There are provided a glass melting apparatus and a glass melting method which are capable of uniformly melting glass materials and shortening or dispensing with a fining process. The glass melting apparatus 200 is comprised of an oscillator 201 having a gyrotron 202 disposed therein for emitting high-frequency waves of 28 GHz, a circular waveguide 203 for transmitting the millimeter waves from the oscillator 201, an applicator 204 having a ceramic furnace 111 disposed therein, and a CPU 205 controlling a thermocouple 206 for measuring the temperature of molten glass within the furnace 111 and a power supply panel 207 for supplying electric power to the oscillator 201. The furnace 111 has an upper part thereof formed with a batch inlet port 112 through which a mixture of glass materials (hereinafter referred to as “the batch”) is charged, and a lower part thereof formed with an outlet end 113 through which the batch melted uniformly by dielectric heating within the furnace 111 is dropped into a bus 121.

### CROSS REFERENCE TO RELATED APPLICATION

This is a continuation of International Application No. PCT/JP2004/012757, filed Aug. 27, 2004.

### TECHNICAL FIELD

The present invention relates to a glass melting apparatus and a glass melting method.

### BACKGROUND ART

The manufacturing of glass comprises (1) a mixing process for mixing glass materials, (2) a melting (vitrifying) process for melting the mixed glass materials (hereinafter referred to as “batch”) by supplying thermal energy to the batch, (3) a forming process for forming a plate glass having a predetermined thickness out of the melted or vitrified batch (hereinafter referred to as “molten glass”), and (4) a annealing process for annealing the formed plate glass (see e.g. Japanese Patent Publication (Kokoku) No. 58-37257 and Japanese Laid-Open Patent Publication (Kokai) No. 2000-281365).

In a float glass manufacturing apparatus, thermal energy used in the process (2) is obtained by heavy oil combustion.

However, the thermal energy obtained by the heavy oil combustion is radiation energy which is a kind of electromagnetic waves of which in a specific wavelength band can be easily absorbed by a batch as an object to be heated but energy of which in the other wavelength bands is only transmitted through the batch without being changed into heat.

Radiation energy is mostly absorbed in the surface of an object to be heated. When the object is formed of steel or the like having high thermal conductivity, the difference in temperature between the surface layer of the object and the inner part of the same is small. However, a batch is composed of materials with lower thermal conductivity than that of steel or the like and further is in a powder form, and hence the difference in temperature between the surface layer of the batch and the inner part of the same is large, which hinders uniform vitrification reaction of the batch in the process (2). As a result, inhomogeneities of the molten glass are caused and remain in the manufactured glass as optical distortions (hereinafter referred to as “striae”). Consequently, it is conventionally required to provide a fining process between the processes (2) and (3), in which convection of the molten glass is caused to thereby prevent striae from being formed, or clarifiers are added to the molten glass to thereby prevent bubbles from remaining in the molten glass.

It is an object of the present invention to provide a glass melting apparatus and a glass melting method which are capable of uniformly melting glass materials and shortening or dispensing with a fining process.

### DISCLOSURE OF INVENTION

To attain the above object, according to the present invention, there is provided a glass melting-apparatus used for manufacturing glass, wherein glass materials are dielectrically heated with high-frequency waves within a sub-millimeter to millimeter wavelength range.

Preferably, the high-frequency waves have a frequency in a range of 10 to 35 GHz.

Preferably, melting of the glass materials is performed by dielectric heating with the high-frequency waves irradiated onto a surface of the glass materials and electric resistance heating using electrodes inserted into the glass materials.

Preferably, the glass melting apparatus includes a melting bath formed by a structure enclosed by a ceiling part, a side wall part, and a bottom part, for receiving the glass materials, and at least an upper structural part of the melting bath above a surface of the glass materials has an inner wall thereof lined with metal, preferably platinum or a platinum alloy.

To attain the above object, according to the present invention, there is provided a glass melting method for manufacturing glass by melting glass materials through dielectric heating performed by irradiating high-frequency waves within a sub-millimeter to millimeter wavelength range onto the glass materials, wherein the glass is a multi-component glass containing alkaline earth metal oxides and Al₂O₃.

Preferably, contents of the glass components in terms of % by mass are SiO₂: 45 to 80%, RO: 5 to 30%, Al₂O₃: 0 to 20%, and B₂O₃: 0 to 20%, and substantially no alkaline components are contained.

Preferably, the glass contains at least one of CaO, BaO, and SrO as an RO component.

Preferably, at least one component selected from the group consisting of SnO₂ and CeO₂ is contained as a clarifier in the glass.

### BRIEF DESCRIPTION OF THE DRAWINGS

FIG. 1 is a schematic view showing the arrangement of a glass melting apparatus according to an embodiment of the present invention;

FIG. 2 is a view useful in explaining a forming process for molten glass melted in a furnace (hereinafter also referred to as “the melting bath”) appearing in FIG. 1;

FIG. 3 is a schematic view useful in explaining dielectric heating;

FIG. 4 shows an equivalent model of dielectric heating;

FIG. 5 is a schematic cross-sectional view of a variation of the glass melting apparatus according to the embodiment of the present invention;

FIG. 6 is a graph showing the relationship between batch materials of amorphous glass and the values of dielectric loss coefficients of the respective batch materials with respect to electromagnetic waves with a frequency of 10 GHz; and

FIG. 7 is a graph showing results of measurement of dielectric loss coefficients of respective clarifiers of various kinds with respect to the electromagnetic waves with a frequency of 10 GHz.

### BEST MODE FOR CARRYING OUT THE INVENTION

The present invention will now be described in detail below with reference to the drawings showing a preferred embodiment thereof.

A glass melting apparatus according to the present embodiment is used as part of a float glass manufacturing apparatus, for example. More specifically, the manufacturing of glass by the float glass manufacturing apparatus comprises a mixing process for mixing glass materials, a melting (vitrifying) process for melting the mixed glass materials (hereinafter referred to as “batch”) by supplying thermal energy to the batch, a forming process for forming a plate glass having a predetermined thickness out of the molten or vitrified batch (hereinafter referred to as “molten glass”), and a annealing process for annealing the formed plate glass. The glass melting apparatus according to the present embodiment is used in the melting (vitrifying) process of the above-mentioned processes.

In the following, the glass melting apparatus according to the present embodiment will be described in detail.

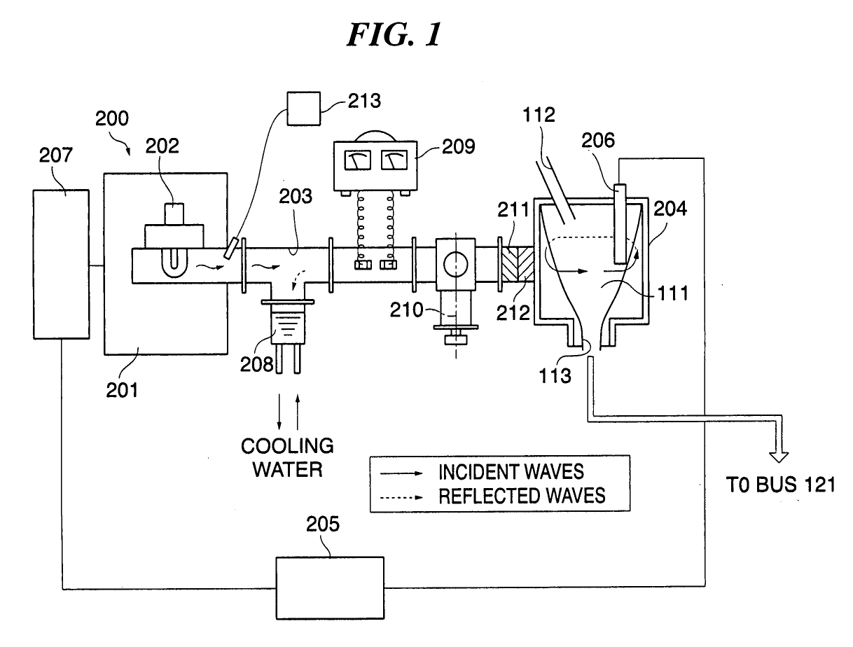

FIG. 1 is a schematic view showing the arrangement of the glass melting apparatus 200 according to the present embodiment.

As shown in FIG. 1, the glass melting apparatus 200 is comprised of an oscillator 201 that contains therein a gyrotron 202 which emits millimeter waves with a frequency of 28 GHz, a circular waveguide 203 that transmits the millimeter waves from the oscillator 201, an applicator 204 that has a ceramic-made furnace 111 disposed therein, and a CPU 205 that controls a thermocouple 206 which measures the temperature of molten glass within the furnace 111 and a power supply panel 207 which supplies electric power to the oscillator 201.

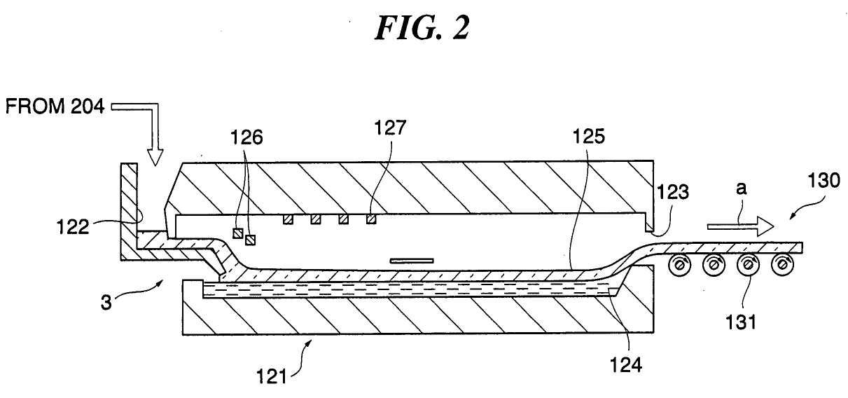

The furnace 111 has an upper part thereof formed with a batch inlet port 112 through which a batch is charged, and a lower part thereof formed with an outlet end 113 through which molten glass is dropped into a bus 121, described hereinafter with reference to FIG. 2. The batch charged through the batch inlet port 112 is uniformly melted by dielectric heating with millimeter waves transmitted through the circular waveguide 203, to form molten glass. The temperature of the molten glass in the furnace 111 is e.g. approximately 1500° C.

The circular waveguide 203 is comprised of an isolator 208 that absorbs therein only excessive reflected power returned from the applicator 204, a power monitor 209 that measures incident power from the oscillator 201 and the reflected power from the applicator 204, a matching device 210 that performs adjustment such that the reflected power measured by the power monitor 209 becomes equal to 0, a mode filter 211 that permits transmission of millimeter waves only in a TE02 mode as the main mode of transmission modes for millimeter waves transmitted through the circular waveguide 203 but inhibits transmission of the millimeter waves in the other modes, a barrier window 212 formed of a silicon nitride plate, for absorbing the reflected power from the applicator 204, and an arc detector 213 that detects waveguide discharge and cooperates with a detector circuit of the oscillator 201 to prevent damage to the oscillator 201 due to generation of arc.

The applicator 204 has the furnace 111 disposed at a location where an electric field from the circular waveguide 203 is strongest, with a cooler, not shown, disposed outside for cooling the periphery of the applicator 204 by cooling water.

Next, a forming process for molten glass melted in the furnace 111 in FIG. 1 will be described with reference to FIG. 1.

In FIG. 2, the molten glass melted in the furnace 111 disposed in the applicator 204 of the glass melting apparatus 200 in FIG. 1 is formed into a glass ribbon 125 within the elongated bus 121 made of firebrick, and is slowly cooled to a solidifying temperature. The glass ribbon 175 cooled to the solidifying temperature is annealed in an annealing section 130.

The bus 121 has an inlet end 122 through which molten glass dropped from the furnace 111 is poured into the bus 121, and an outlet end 123 through which the glass ribbon 125, described hereinafter, formed of the molten glass in the bus 121 flows out after being cooled down to the solidifying temperature, provided at respective longitudinally opposite ends thereof.

Further, the bus 121 has a bottom part thereof filled with molten metal 124 formed of tin etc., and when the molten glass is poured into the bus 121 via the inlet end 122, the molten glass floats on the molten metal 124, to form the glass ribbon 125. At a location immediately downstream of the inlet end 122 and above the glass ribbon 125, there is disposed a cooler 126. The glass ribbon 125 is cooled to a predetermined temperature by the cooler 126. At a location downstream of the cooler 126 and above the glass ribbon 125, there are arranged a plurality of electric heaters 127. The glass ribbon 125 is controlled to its solidifying temperature e.g. of 900° C. Further, at a location downstream of the electric heaters 127 and above the molten metal 124, there are arranged a pair of electromagnetic induction heating coils (not shown) from which an eddy current is generated. When the eddy current flows in the molten metal 124 against the electric resistance thereof, the Joule heat is generated to heat the molten metal 124. However, the glass ribbon 125 is an insulator, and hence when the eddy current flows toward the glass ribbon 125, the Joule heat is not generated, and hence the glass ribbon 125 is not heated. Thus, the temperature of the molten metal 124 is kept uniform in the bus 121.

The annealing section 130 is provided with e.g. four driving rollers 131, for drawing the glass ribbon 125 formed in the bus 121. The glass ribbon 125 is drawn by the driving rollers 131 in a direction indicated by an arrow “a” in FIG. 2 at a predetermined speed e.g. of 0.2 m/sec., whereby a plate glass with a desired thickness is formed.

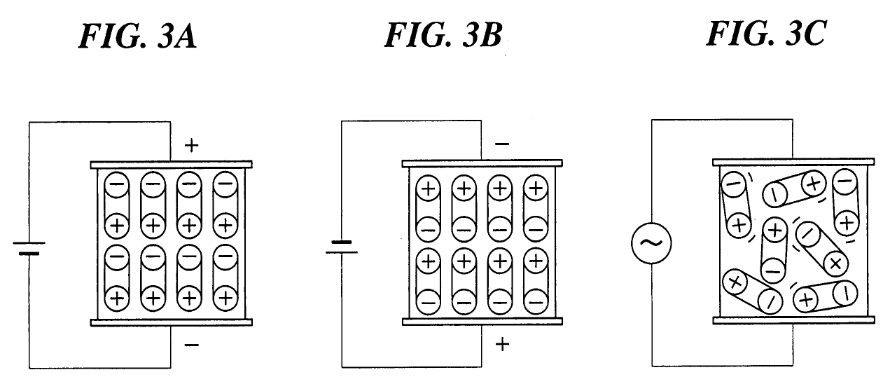

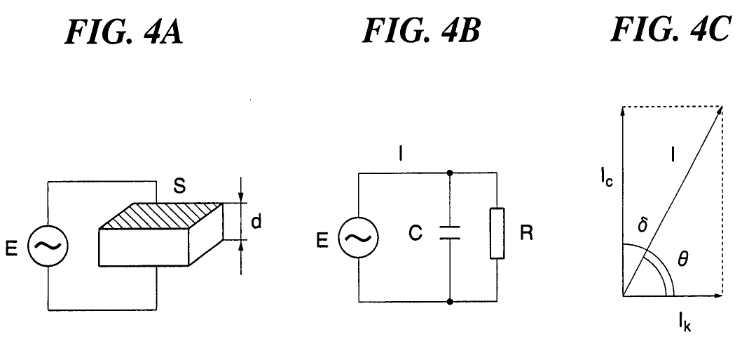

Next, the principle of dielectric heating performed by the glass melting apparatus 200 in FIG. 1, for dielectrically heating the batch, will be described with reference to FIGS. 3 and 4.

Dielectric heating is a heating method in which a dielectric is placed in a high-frequency electric field and heated with heat generated by dielectric loss of the dielectric itself. As shown in FIG. 3, when a voltage is applied to a dielectric placed between electrode plates opposed to each other, molecules and polar radicals forming the dielectric move to be arranged in the direction of the electric field. At this time, in the high-frequency electric field whose alternating period is short, heat is generated by friction between the molecules due to high-speed vibration and rotation. Assuming that in FIG. 4, an electrode area is represented by S (m²), an electrode distance by d (m), the relative dielectric constant of the dielectric by εᵣ, the dielectric loss tangent of the same by tanδ, the frequency by f (Hz), the voltage by E (V), and the resistance by R, the capacity C of the capacitor and the dielectric loss tangent tanδ satisfy the relationship expressed by the following equations:
C=ε₀×εᵣ×S/d(F) (1)

(ε₀: vacuum dielectric constant)
tanδ=1/(R×2πfC) (2)

Therefore, electric power P required for heat generation in the dielectric can be expressed by the following equation derived from the equations (1) and (2):

$$\begin{matrix}P = {E}^{2} / R = {E}^{2} \times tan δ \times 2 π fC \\ = {E}^{2} \times tan δ \times 2 π fC \times {ɛ}_{0} \times {ɛ}_{r} \times S / d ( W )\end{matrix} \qquad ( 3 )$$

Consequently, electric power per unit volume required for heat generation is proportional to the square of the strength of the electric field (E/d), the frequency f, the relative dielectric constant εᵣ, and the dielectric loss tangent tanδ. The product εᵣ·tanδ is referred to as the dielectric loss coefficient, which serves as a guide for determining the ease of dielectric heating.

As described above, as is distinct from the other heating methods dependent on transfer of heat from an external heat source by radiation, conduction, and convection, dielectric heating is based on heat generation from a to-be-heated object itself. Therefore, (1) quick and uniform heating can be performed without necessitating heat conduction by substance itself, (2) the temperature of the to-be-heated object is increased by the object itself basically without necessitating an increase in the temperature of the furnace or the ambient temperature, which improves heating efficiency, (3) when the high-frequency power is applied, the temperature quickly rises with an excellent heating response, which makes it easy to perform control, (4) selective heating can be performed since heat generation depends on the characteristic εᵣ·tanδ of a substance itself, and (5) heating can be performed under a reduced pressure or in a special atmosphere.

On the other hand, when the batch is irradiated with microwaves, since the microwaves are electromagnetic waves long in wavelength, the sizes of molecules forming the batch are equal to or shorter than the wavelength of the microwaves. Therefore, microwave energy is once converted into heat, and the batch is heated by the heat, so that the heating efficiency is lower.

In contrast, when high-frequency waves within a wavelength range of sub-millimeters (10 to 30 GHz) to millimeters (30 to 300 GHz) shorter than the wavelengths of the microwaves is used, the molecules forming the batch are directly heated (dielectrically heated) differently from the case where the microwaves are used, and therefore heating efficiency is enhanced. Further, when facility economy of the high-frequency oscillator is taken into consideration, high-frequency waves of 10 to 35 GHz are preferable, and high-frequency waves of 25 to 35 GHz are more preferable.

In short, it is possible to melt the batch efficiently and uniformly by dielectrically heating the batch using high-frequency waves within the wavelength range of sub-millimeter to millimeter as described above.

In the following, a description will be given of inconveniences that occur in conventional non-uniform melting of batches.

(1) Generation of Striae in Glass

When the melting temperature in a batch is non-uniform, different reactions occur at respective melting temperatures shown in Table 1, and different kinds of glasses are formed into a stripe pattern. Thus, striae are generated in the glass.

TABLE 1

| Temperature (° C.) | Reaction |
|---|---|
| 39-598 | Na₂CO₃ + SO₂ [symbol] Na₂SO₃(593° C.) + CO₂ |
| 300 | Na₂CO₃ + MgCO₃ [symbol] Na₂Mg(CO₃)₂ |
| 300 | MgCO₃ [symbol] MgO + CO₂(REACTION STARTS) |
| 620 | THE ABOVE REACTION COMPLETES |
| 307 | 2NaNO₃ + SiO₂ [symbol] Na₂SiO₃ + 2NO + ½O₂ |
| 400 | Na₂CO₃ + CaCO₃ [symbol] Na₂Ca(CO₃)₂ |
| 420 | CaCO₃ [symbol] CaO + CO₂(REACTION STARTS) |
| 900 | THE ABOVE REACTION COMPLETES |
| 340-620 | MgNa₂(CO₃)₂ + 2SiO₃ [symbol] MgSiO₃ + Na₂SiO₃ + 2CO₂ |
| 450-700 | MgCO₃ + SiO₂ [symbol] MgSiO₃ + CO₂ |
| 585-900 | CaNa₂(CO₃)₂ + SiO₂ [symbol] CaSiO₃ + Na₂SiO₃ + 2CO₂ |
| 600 | 4Na₂SO₃ [symbol] 3Na₂SO₄ + Na₂S(REACTION STARTS) |
| 700 | THE ABOVE REACTION ACCELERATES |
| 680 | BaCO₃ + Na₂CO₃ EUTECTIC POINT |
| 700 | Na₂CO₃ + SiO₂ [symbol] Na₂SiO₃(SOLID) + CO₂ |
| 740 | Na₂SO₄ + Na₂S EUTECTIC POINT |
| 740 | Na₂SO₄ + 2C [symbol] Na₂S + 2CO₂ |
| 801 | 2NaCl + SiO₂ + ½O₂ [symbol] Na₂SiO₃ + Cl₂ |
| 812 | MELTING POINT OF DOUBLE SALT |
| 860 | Na₂SO₄ + Na₂S + SiO₂ [symbol] 2Na₂SiO₃ + SO₂ + S |
| 900 | 3Na₂SO₄ + Na₂S [symbol] 4Na₂O + 4SO₂ |
| 900 | Na₂SO₄ [symbol] Na₂O + SO₂ |
| 1038 | GENERATION OF INITIAL MELT |
| 1288 | Na₂SO₄ + HEAT [symbol] Na₂O(GLASS) + SO₂ + ½O₂ |
| 1428 | SO₃(GLASS) [symbol] SO₂ + ½O₂(REBOIL) |

Portions with striae are basically colorless. However, the refractive index of each of the portions is different from that of the matrix of glass surrounding the portion, which causes distortion of images in optical glass or plate glass, or degradation of transparency and reflecting proportions of the optical glass or the plate glass. Further, in the glass of a glass container, such as a bottle, distortion occurs due to differences in expansion coefficient between homogeneous portions and inhomogeneous portion, which results in degradation of the strength of the container.

(2) Generation of Bubbles in Glass

When the batch is vitrified in the melting process, it releases gases, such as CO₂, H₂O, O₂, and SO₂, and part of the gases remaining in the molten glass forms bubbles in glass.

Next, a variation of the glass melting apparatus according to the embodiment of the present invention will be described with reference to drawings.

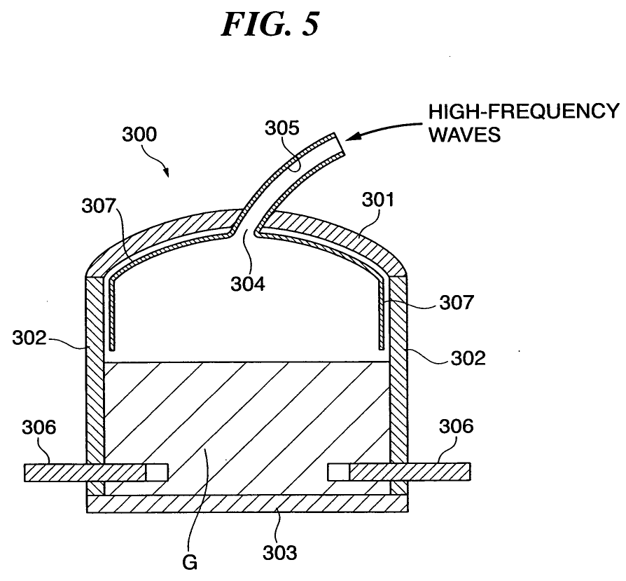

FIG. 5 is a schematic cross-sectional view of the variation of the glass melting apparatus according to the embodiment of the present invention.

As shown in FIG. 5, the glass melting apparatus 300 is enclosed by a ceiling part 301, a side wall part 302, and a bottom part 303. A waveguide 305 is connected via an opening 304 formed in the zenith portion of the ceiling part 301. The waveguide 305 is connected to an oscillator provided with a gyrotron, not shown. An electric heating electrode pair 306 are inserted through portions of the side wall part 302 of the glass melting apparatus 300 at respective locations close to the bottom part 303 of the same. Further, the ceiling part 301 and portions of the side wall part 302 kept from contact with glass materials are lined with a thin plate 307 formed of a metal, preferably a platinum or a platinum-rhodium alloy.

The glass materials G have the surface and inner part thereof dielectrically heated by high-frequency waves in a sub-millimeter to millimeter band irradiated onto the surface of the glass materials G through the opening 304. At the same time, the glass materials G are heated by the electric resistance heating electrode pair 306. Thus, the glass materials are melted by dielectric heating performed from above with the high-frequency waves and conductive heating from the bottom part thereof. Electromagnetic waves released from the surface of the glass materials into an upper space within the glass melting apparatus 300 without being absorbed into the glass materials are reflected on the thin plate 307 of platinum or the like, and enter the glass materials again, thereby contributing to heating of the glass materials.

Next, a description will be given of batch materials of glass to be melted by the glass melting apparatus 200 or 300 according to the embodiment of the present invention.

Glass materials mixed in a batch at a predetermined blending ratio are heated up, whereby decomposition reactions take place in the respective glass materials as shown in Table 1, and the glass materials are progressively vitrified into an amorphous glass state while reacting with each other. It is considered that in the early stages (relatively low temperatures) of the melting process, reactions, such as decomposition reactions and solid solution-forming reactions, shown in Table 1 take place in the glass materials, and in the middle and late stages of the melting process, reactions and the like between reaction products of some glass materials and those of other glass materials are added to the above-mentioned reactions, whereby the vitrification proceeds through the complicated reactions. For a reaction of an individual glass material to take place, it is required to heat up the glass material to a temperature not lower than a predetermined temperature (shown e.g. in Table 1). That is, a batch with better dielectric heating efficiency is more preferable as one to be melted by the glass melting apparatus 200 or 300 according to the embodiment of the present invention.

In the following, a description will be given of preferred amorphous glass batch materials to be melted by the glass melting apparatus 200 or 300 according to the embodiment of the present invention.

The glass components of amorphous glass include, in addition to SiO₂ and B₂O₃ as basic components of glass, part or all of Al₂O₃ for maintaining chemical properties, such as water resistance, divalent (alkaline earth) metal oxides (RO═CaO, MgO, SrO, BaO, ZnO) for adjusting the viscosity of glass during fining and formation, and monovalent (alkali) metal oxides (R₂O═Na₂O, K₂O, Li₂O) for enhancing the solubility of glass and for adjusting glass viscosity in a high-temperature range. The composition of a batch is set such that the batch contains the glass components in appropriate amounts depending on the application of a glass product to be manufactured. In the case of manufacturing glass products, such as glass substrates for TFT liquid crystal display devices, wherein it is not desired that glass contains alkaline components, the batch composition is set such that non-alkaline glass containing substantially no alkaline components is formed.

Further, added to the batch are not only the above-mentioned glass components, but also clarifiers for effectively removing bubbles generated in the vitrifying melting process from the molten glass. Furthermore, a coloring agent and the like are added to the batch as required.

Insofar as oxide components are concerned, carbonates, nitrates, sulfates, hydroxides, etc. of metals are used as batch materials. Above all, the nitrates and sulfates are often used. In many cases, for the SiO₂ component, silica sand is used, for the B₂O₃ component, boric acid (H₃BO₃), and for the Al₂O₃ component, alumina, aluminum hydroxide, or aluminum carbonate boric acid (H₃BO₃), and for the Al₂O₃ component, alumina, aluminum hydroxide, or aluminum carbonate.

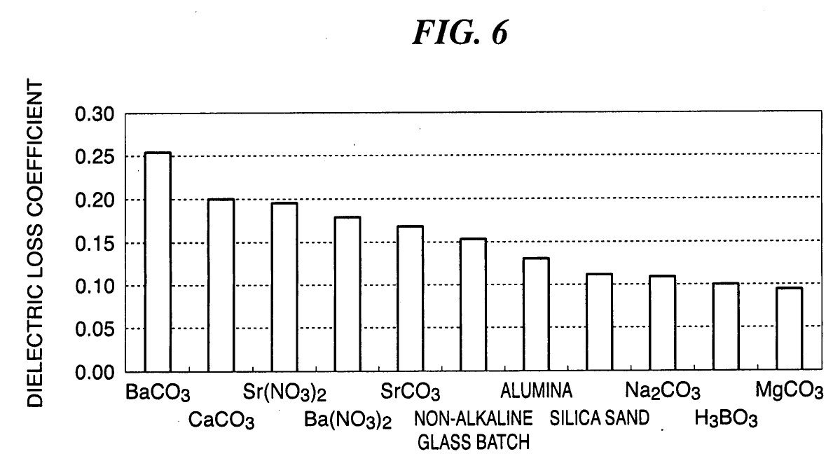

FIG. 6 is a graph showing the relationship between the amorphous glass batch materials and the values of dielectric loss coefficients of the respective batch materials with respect to electromagnetic waves with a frequency of 10 GHz.

In FIG. 6, not only the dielectric loss coefficient values of the respective batch materials of the amorphous glass, but also that of a non-alkaline glass batch is shown at the same time. The non-alkaline glass batch in FIG. 6 is for use in TFT liquid crystal displays, and the composition thereof contains 59% by mass of SiO₂, 12% by mass of B₂O₃, 14% by mass of Al₂O₃, 4.5% by mass of CaO, 6% by mass of BaO, 3% by mass of SrO, and 0.5% by mass of MgO (15% by mass of RO in total), and 0.5% by mass of SnO₂, and 0.5% by mass of CeO₂ as clarifiers.

FIG. 6 also shows the values of the dielectric loss coefficients of the amorphous glass batch materials, i.e. silica sand which is a glass material containing the SiO₂ component as a basic glass component, boric acid (H₃BO₃) which is a glass material containing the B₂O₃ component as another basic glass component, alumina which is a glass material containing the Al₂O₃ component for securing chemical properties, such as water resistance, BaCO₃, CaCO₃, Sr(NO₃)₂, Ba(NO₃)₂, SrCO₃, and MgCO₃ which are glass materials containing the RO components for adjusting glass viscosity during fining and formation of glass, and Na₂CO₃ representative of glass materials containing the R₂O components for enhancing glass solubility and adjusting glass viscosity in a high-temperature range.

It is understood that the values of the dielectric loss coefficients of BaCO₃, CaCO₃, Sr(NO₃)₂, Ba(NO₃)₂, and SrCO₃ among the glass materials containing the RO components are larger than that of silica sand as a glass material containing the SiO₂ component. Therefore, it is understood that a batch containing these components in larger amounts has larger heat absorbing efficiency in heating by irradiation of millimeter waves, so that the batch can be efficiently heated up, which is preferable in dielectric heating and melting.

Further, although not shown in FIG. 6, the following results were obtained as to the glass materials containing the RO components:

For the CaO component, calcium carbonate, calcium sulfate, and calcium hydroxide have respective dielectric loss coefficient values in the decreasing order, which are all larger than that of silica sand, and therefore it can be expected that the carbonate can be efficiently heated up.

For the BaO component, barium carbonate, barium nitrate, and barium sulfate have respective dielectric loss coefficient values in the decreasing order, which are all larger than that of silica sand, and therefore it can be expected that the sulfate, the carbonate, and the nitrate can be efficiently heated up.

For the SrO component, strontium nitrate and strontium carbonate have respective dielectric loss coefficient values in the decreasing order, which are both larger than that of silica sand, and therefore it can be expected that the nitrate and the carbonate can be efficiently heated up.

For the MgO component, magnesium hydroxide, magnesium sulfate, and magnesium carbonate may be mentioned, and magnesium hydroxide is the largest of the three in the dielectric loss coefficient value. However, it was found that the dielectric loss coefficient value of magnesium hydroxide is smaller than that of silica sand, and hence the rate of temperature rise by heating thereof is low.

It was also found that the dielectric loss coefficient value of alumina as a glass material containing the Al₂O₃ component is larger than that of silica sand as a glass material containing the SiO₂ component. Further, it was found that although boric acid as a glass material containing the H₃BO₃ component is also a trivalent metal oxide, the dielectric loss coefficient value thereof is slightly smaller than that of silica sand as a glass material containing the SiO₂ component. Furthermore, it was found that a batch of aluminoborosilicate glass or aluminosilicate glass containing a large amount of alumina can be efficiently heated up for the above described reason.

On the other hand, insofar as Na₂CO₃ as a glass material containing the Na₂O component is concerned, it was found that Na₂CO₃, which is known to have a low decomposition reaction temperature and act to lower vitrifying liquid phase temperature, is a glass material hard to be heated up by high-frequency dielectric heating. Further, although not shown in FIG. 6, it was found that the same applies to the dielectric loss coefficient value of potassium carbonate as a glass material containing the K₂O component included in the R₂O components. Therefore, it was found that the non-alkaline glass batch can be more efficiently heated up than a batch containing the R₂O components, for the above described reasons.

From the above results, it was found that the batch materials of aluminoborosilicate glass or aluminosilicate glass containing large amounts of glass materials containing the RO (BaO, CaO, and SrO) components, particularly the batch materials of non-alkaline aluminoborosilicate glass are preferable for melting by the glass melting apparatus 200 or 300, in that the batch can be efficiently heated up.

More specifically, as a preferred example of the glass composition which can be efficiently heated up by the dielectric heating method of the present invention, there may be mentioned aluminosilicate glass or aluminoborosilicate glass which contains 45 to 80% by mass of SiO₂, 5 to 30% by mass of RO, 0 to 20% by mass of Al₂O₃, and 0 to 20% by mass of B₂O₃, but substantially no alkaline metal oxide components.

The SiO₂ component is an essential component for vitrification, which forms the network of an amorphous network structure of glass. If the content of the SiO₂ component is less than 45%, chemical resistance is reduced, whereas if the content of the SiO₂ component is more than 80%, high-temperature viscosity increases, making it difficult for homogeneous melting to occur and easy to cause devitrification.

The Al₂O₃ component not only efficiently absorbs high-frequency waves, to be easily heated up, but also enhances the heat resistance and water resistance of glass. Preferably, the content of the Al₂O₃ component is 0 to 20%. If the content of the Al₂O₃ component exceeds 20%, hydrofluoric acid resistance is reduced. When a glass material containing the Al₂O₃ component exceeding 20% is used for a glass substrate for TFT liquid crystal displays, the property of resistance against hydrofluoric acid required in forming TFT elements on the glass is degraded.

The RO components except MgO efficiently absorb high-frequency waves by their metal salts to form glass that can be easily heated up. When not less than 5% by mass of RO components are contained in the glass, high-temperature viscosity is reduced and excellent meltability is secured, thereby preventing devitrification of the glass. Above all, CaO, BaO, and SrO are preferable from the viewpoint that they can be easily heated up. However, if the content of the RO components exceeds 30%, although the heating-caused temperature rise property of the batch is enhanced, the acid resistance and heat resistance of the glass are degraded.

Similarly to the SiO₂ component, B₂O₃ is a component for forming the network of the amorphous network structure of glass. The B₂O₃ component reacts with other components to lower the liquid phase temperature and reduce the glass viscosity, thereby facilitating vitrification melting. If the content of the B₂O₃ component exceeds 20% by mass, the acid resistance is reduced, and the strain point of the glass is lowered to degrade the heat resistance. In many cases, boric acid is used as a glass material containing the B₂O₃ component. Although boric acid, which is slightly smaller in the dielectric loss coefficient value than SiO₂, is not a component which can be efficiently heated up, it provides a useful effect of lowering the melt-forming temperature of glass.

A batch which can be easily heated up contains SiO₂, Al₂O₃, and RO in not less than a total amount of 75% by mass, and more preferably in 80% by mass.

Next, a description will be given of a batch of silica-based multi-component glass preferably used as a batch to be melted by the glass melting apparatus 200 or 300 according to the embodiment of the present invention.

The glass components of the silica-based multi-component glass include some or all of SiO₂ as an essential component of glass, monovalent metal oxides (R₂O), divalent metal oxides (RO), and trivalent metal oxides (Al₂O₃ and B₂O₃), and further, tetravalent metal oxides, as needed. The composition of the batch is set such that it contains the glass components in appropriate amounts depending on the application of a glass product to be manufactured.

Further, added to the batch are not only the above-mentioned glass components, but also clarifiers for effectively removing bubbles generated in the vitrification melting process from the molten glass. Furthermore, a coloring agent and the like are added to the batch as required.

The R₂O components generally used as batch materials are the carbonate, nitrate, and sulfate of each of sodium, potassium, and lithium. The RO components generally used are the carbonate, nitrate, and sulfate of each of calcium, magnesium, barium, strontium, and zinc. The tetravalent metal oxides used as glass materials are the oxides of titanium and zirconium. Further, in many cases, for the SiO₂ component, silica sand is used, for the B₂O₃ component, boric acid (H₃BO₃), and for the Al₂O₃ component, alumina and aluminum hydroxide.

Further, it was found that when a batch contains smaller amounts of glass materials containing the R₂O components, larger amounts of glass materials containing BaO, CaO, and SrO as the RO components, and an larger amount of alumina as a glass material containing Al₂O₃ as the R₂O₃ component, the batch can be efficiently heated up by high-frequency dielectric heating.

From the above results, it was found that a batch of aluminosilicate glass containing the RO (BaO, CaO, SrO) glass components in large amounts, particularly a batch of non-alkaline aluminosilicate glass is preferable for melting by the glass melting apparatus 200 or 300, in that the batch can be efficiently heated up.

Next, a description will be given of clarifiers added to a batch to be melted by the glass melting apparatus 200 or 300 according to the embodiment of the present invention.

In molten glass, CO₂, SO₂, O₂, H₂O, and so forth generated by vitrification reactions shown e.g. in Table 1 remain as bubbles enclosed by the glass. These bubbles form bubble flaws in glass products. The bubbles generated in the melting process are removed from the molten glass through fining (degassing) with clarifiers added to the batch. The clarifiers include redox oxides (metal oxide which can have a plurality of valences), such as tin oxide (SnO₂), cerium oxide (CeO₂), calumite, molybdenum oxide (MoO₃), and vanadium oxide (V₂O₅), halogen compounds, such as calcium fluoride (CaF₂) and sodium chloride (NaCl), and other compounds, such as sodium sulfate (Na₂SO₄). A temperature range where a clarifier exerts a fining effect differs depending on the kind of a batch.

The present inventors had an idea that if the clarifiers themselves are heated in glass melted by heating through efficient absorption of high-frequency-waves energy, decomposition of the molecules of the clarifiers and oxygen release are promoted, whereby degassing of the glass is further effectively performed, and based on the idea have studied the values of the dielectric loss coefficients of the clarifiers.

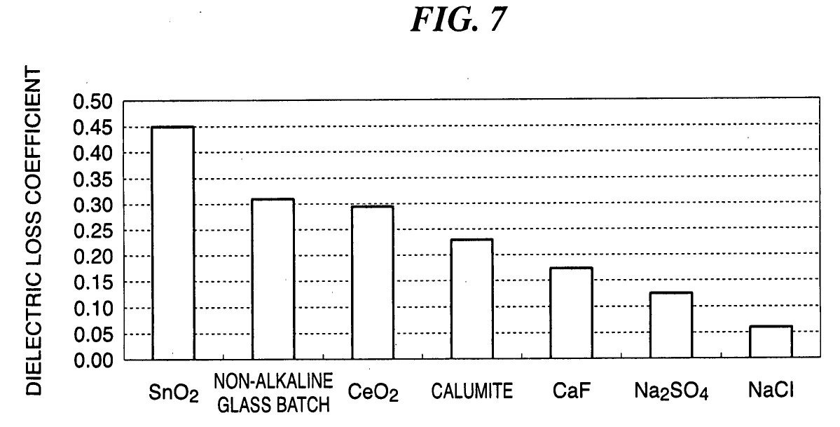

FIG. 7 is a graph showing the results of measurement of the dielectric loss coefficients of respective clarifiers of various kinds with respect to electromagnetic waves with a frequency of 10 GHz.

The values of the dielectric loss coefficients of SnO₂, CeO₂, calumite, CaF, Na₂SO₄, and NaCl selected from the compounds for use as clarifiers were measured. It is considered that each of these clarifiers has a maximum oxygen release range within a temperature range of approximately 1450 to 1700° C., though depending on the composition of glass.

When taking into account the fact that a clarifier itself is heated not only by heat transferred from molten glass surrounding the clarifier but also by absorption of high-frequency-waves energy, the use of clarifiers with larger dielectric loss coefficient values is preferable in that the clarifiers can be kept more efficiently heated to a high temperature in molten glass. From this viewpoint, SnO₂ and CeO₂ form the most preferable clarifier group, as shown in FIG. 7, and calumite, CaF, NaCl, and Na₂SO₄ follow SnO₂ and CeO₂ decrease in the dielectric loss coefficient value in the mentioned order. In the present invention, it is preferred that the clarifier is normally contained in approximately 0.5 to 1% by mass of all glass components.

The dielectric loss coefficient values of the respective glass materials in FIGS. 6 and 7 are obtained when the frequency of high-frequency waves is set to 10 GHz, but it was found that even if the frequency of high-frequency waves is higher, the order of the glass materials in respect of the magnitude of the dielectric loss coefficient value does not largely change. More specifically, the metal salts of many of the alkaline earth metal oxides are larger in the dielectric loss coefficient value than silica sand, alumina, and boric acid, whereas the salts of the alkaline metal oxides are smaller in the dielectric loss coefficient value than silica sand, alumina, and boric acid. In the present invention, although the frequency of high-frequency waves for use in heating up glass materials may be set within a range of 10 to 300 GHz for dielectric heating of glass materials forming a batch, when facility economy of the high-frequency oscillator is taken into account, it is preferred that the frequency is set within a range of 10 to 35 GHz, and more preferably, within a range of 25 to 35 GHz.

### EXAMPLES

Hereafter, Examples of the present invention will be described.

(1) Dielectric Heating Experiment on Batch A

300 g of batch A was prepared by mixing the glass materials of silica sand, aluminum hydroxide, magnesium carbonate, calcium carbonate, sodium carbonate, and potassium carbonate, such that the batch A contains 71.8% by mass of SiO₂, 2% by mass of Al₂O₃, 4% by mass of MgO, 8% by mass of CaO, 13% by mass of Na₂O, 1% by mass of K₂O, and 0.2% by mass of SO₃. This batch was placed in a platinum crucible, and the crucible was set in the furnace. Then, the batch was heated by three kinds of batch heat-up methods described below, and samples of molten glasses (Example 1, Comparative Examples 1 and 2) were obtained for comparison between the characteristics thereof.

The batch was melted by the following three methods: (1) a method of performing radiation heating by a radiation heater disposed on a ceiling wall within the furnace (Comparative Example 2), (2) a method of generating high-frequency waves of 2.45 GHz by the gyrotron and guiding the same to glass materials through the waveguide for irradiation onto the glass materials for dielectric heating thereof (Comparative Example 1), and (3) a method of generating high-frequency waves of 28 GHz by the gyrotron and guiding the same to glass materials through the waveguide for irradiation onto the glass materials for dielectric heating thereof (Example 1).

The results of checking unmolten residues in a molten glass (Example 1) melted by heating up by irradiation of the high-frequency waves of 28 GHz are shown in Table 2. No unmolten residues could be observed in the glass in the crucible by the naked eye, and the entire batch was in a molten and vitrified state.

The results of checking unmolten residues in a molten glass (Comparative Example 1) melted by heating up by irradiation of the high-frequency waves of 2.45 GHz are shown in Table 2. Unmolten residues were observed in the glass in the crucible, and the batch was not sufficiently melted.

Unmolten residues were observed in a glass (Comparative Example 2) melted by heating up with radiation heat using the infrared heater under heating conditions shown in Table 2, and the batch was not sufficiently melted.

From the above described results, it is understood that a glass without unmolten residues can be formed by melting glass materials by irradiation of the sub-millimeter high-frequency waves of 28 GHz. It can be considered that this is because the glass materials were effectively absorbed in the high-frequency waves of 28 GHz, and effectively dielectrically heated at a high rate of temperature rise by heating.

(2) Dielectric Heating Experiment on Batch B

To 300 g of a batch B composed of 58% by mass of SiO₂ (silica sand: hereafter glass material used is shown in parentheses), 11% by mass of B₂O₃ (boric acid), 15% by mass of Al₂O₃ (alumina), 1% by mass of MgO (magnesium carbonate), 5% by mass of CaO (calcium carbonate), 3% by mass of SrO (strontium nitrate), and 6% by mass of BaO (barium nitrate) (15% by mass of RO in total), there are added 0.5% by mass of SnO₂ and 0.5% by mass of CeO2 as clarifiers (Example 2), and to the same batch B, there are added 0.5% by oxide mass of CaF and 0.5% by oxide mass of NaCl as clarifiers (Comparative Example 3), whereby two kinds of batches were prepared. Each of these batches was placed in a platinum crucible, and the crucible was set in the furnace. Then, high-frequency waves of 28 GHz were generated by the gyrotron and guided to the batch through the waveguide to be irradiated onto the batch, whereby the batch was melted by dielectric heating to form a glass. As a result, in neither of the samples (Example 2 and Comparative Example 3), unmolten residues could be observed in the glass in the crucible by the naked eye, but the entire glass was in a molten state.

Further, the molten glasses were subjected to fining at 1650° C. over an hour after heating and melting as shown in Table 2, and then annealed, whereafter the annealed glass masses were taken out and compared. As a result, fine bubbles in the molten glass in Example 2 have dramatically decreased in number, compared with those in the molten glass in Comparative Example 3 which had no clarifiers added thereto.

TABLE 2

| | | | Hearting | Maximum | Maximum Temperature | | |
|---|---|---|---|---|---|---|---|
| | | | Rate | Temperature | Maintaining Time Period | Unmolten | Fine Bubbles in |
| | Heat Source | Clarifier | (° C./min) | (° C.) | (min) | Residues | Molten Glass |
| Example 1 | 28 GHz High- | | 5 | 1450 | 15 | No Residues | |
| | Frequency Waves | | | | | | |
| Comparative | 2.45 Hz High- | | 5 | 1450 | 15 | White | |
| Example 1 | Frequency Waves | | | | | Residues | |
| Comparative | Infrared Radiation | | 5 | 1450 | 15 | White | |
| Example 2 | | | | | | Residues | |
| Example 2 | 28 GHz High- | SnO₂ + CeO₂ | 5 | 1550 | 15 | No Residues | Very Few |
| | Frequency Waves | | | | | | |
| Comparative | 28 GHz High- | | 5 | 1550 | 15 | No Residues | Many |
| Example 3 | Frequency Waves | | | | | | |

The glass melting apparatus according to the present embodiment is used for meting glass materials of float glass, melting glass for long glass fibers, melting glass for optical fibers in a spinning furnace, melting non-alkaline glass for use in liquid crystal displays by a down-draw method, and the like glass melting.

Further, the present apparatus can be applied to garbage incinerators and the like from the viewpoint of reduction of heating costs, suppression of generation of toxic gases, and so forth.

### INDUSTRIAL APPLICABILITY

As described in detail heretofore, according to the glass melting apparatus of the present invention, glass materials are dielectrically heated using high-frequency waves in a wavelength range of sub-millimeter to millimeter. Therefore, the glass materials can be uniformly melted, and the fining process can be shortened or dispensed with.

With the glass melting apparatus according to the present embodiment, the high-frequency waves are in a frequency range of 25 to 35 GHz, and hence it is possible to more reliably perform uniform melting of glass materials.

Further, with the glass melting apparatus according to the present embodiment, portions of the glass materials remote from the surface of the same (i.e. portions deep from the molten glass base material surface) are heated by dielectric heating with electromagnetic waves penetrating via the glass base material surface and electrode heating through energization of electrodes, and portions of the glass materials close to the glass base material surface are dielectrically heated, which makes it possible to promote convection of the glass materials in the direction of depth, whereby the glass materials can be heated. Furthermore, since glass melting is performed by a combination of dielectric heating from the surface of the glass materials and conductive heating from within the glass materials (batch), the amount of heat required for glass melting can be shared between dielectric heating and resistance heating, which makes it possible to reduce the size of a high-frequency wave generation facility and that of a resistance heating power supply facility, thereby improving facility economy.

With the glass melting apparatus according to the present embodiment, while the high-frequency waves irradiated onto the glass base material surface are absorbed in the glass material and consumed for heat-up, part thereof is reflected upward from the surface of glass materials. Since the inner wall of a structure formed by the ceiling part and/or portions of the side wall part which are not covered with the glass base material is lined with a metal, preferably with platinum or a platinum alloy, it is possible to enhance heating efficiency by causing the high-frequency waves to be reflected and incident on the glass base material surface again. Further, the structure is made of firebrick and has an inner wall thereof lined with a thin plate of metal, preferably with a thin plate of platinum or a platinum rhodium alloy, which contributes to improvement of facility economy.

As described in detail heretofore, according to the glass melting method of the present invention, non-alkaline aluminoborosilicate glass contains, in addition to the SiO₂ component as the main component, the Al₂O₃ component and the RO components as essential components, and these glass materials (starting materials) are high in the efficiency of absorbing electromagnetic waves in a frequency range of a sub-millimeter to millimeter wave band, so that the glass materials can be efficiently heated up by dielectric heating performed by irradiation of high-frequency waves, which makes it possible to achieve glass melting without leaving unmolten residues.

According to the glass melting method of the present embodiment, a batch contains substantially no alkaline components, but the RO components in a large amount, and preferably, at least one of CaO, BaO, and SrO is included in the RO components. Therefore, the value of the dielectric loss coefficient of the batch is large, and therefore the heat-up of the batch is facilitated.

According to the glass melting method of the present embodiment, at least one component selected from the group consisting of SnO₂ and CeO₂ is contained as a clarifier in the molten glass. Therefore, since the clarifier is approximately equal to or larger in the value of the dielectric loss coefficient than the molten glass, it is effectively heated in the molten glass, which-promotes decomposition reaction to release oxygen, thereby effectively achieving fining.

1. A glass melting apparatus used for manufacturing glass,
wherein glass materials are dielectrically heated with high-frequency waves within a sub-millimeter to millimeter wavelength range.

2. A glass melting apparatus as claimed in claim 1, wherein the high-frequency waves have a frequency in a range of 10 to 35 GHz.

3. A glass melting apparatus as claimed in claim 1, wherein melting of the glass materials is performed by dielectric heating with the high-frequency waves irradiated onto a surface of the glass materials and electric resistance heating using electrodes inserted into the glass materials.

4. A glass melting apparatus as claimed in claim 3, including a melting bath formed by a structure enclosed by a ceiling part, a side wall part, and a bottom part, for receiving the glass materials, and
wherein at least an upper structural part of the melting bath above a surface of the glass materials has an inner wall thereof lined with platinum or a platinum alloy.

5. A glass melting method for manufacturing glass by melting glass materials through dielectric heating performed by irradiating high-frequency waves within a sub-millimeter to millimeter wavelength range to the glass materials,
wherein the glass is a multi-component silicate glass containing alkaline earth metal oxides.

6. A glass melting method as claimed in claim 5, wherein the high-frequency waves have a frequency in a range of 10 to 35 GHz.

7. A glass melting method as claimed in claim 5 or 6, wherein contents of the glass components in terms of % by mass are:
SiO₂: 45 to 80%,
RO: 5 to 30%,
Al₂O₃: 0 to 20%, and
B₂O₃: 0 to 20%
and substantially no alkaline components are contained.

8. A glass melting method as claimed in claim 7, wherein the glass contains at least one of CaO, BaO, and SrO as an RO component.

9. A glass melting method as claimed in claim 7, wherein at least one component selected from the group consisting of SnO₂ and CeO₂ is contained as a clarifier in the glass.
